(19) United States
(12) Patent Application Publication
(10) Pub. No.: US 2023/0307764 A1
(43) Pub. Date: Sep. 28, 2023

(54) TRACTION BATTERY PACK ASSEMBLING METHOD

(71) Applicant: Ford Global Technologies, LLC, Dearborn, MI (US)

(72) Inventors: Marc Dugas, Wixom, MI (US); Jason C. Marcath, Dearborn, MI (US)

(21) Appl. No.: 17/867,884

(22) Filed: Jul. 19, 2022

Related U.S. Application Data
(60) Provisional application No. 63/322,766, filed on Mar. 23, 2022.

(51) Int. Cl. H01M 50/258; H01M 50/249; H01M 50/209; H01M 50/224

(52) U.S. Cl. CPC H01M 50/258; H01M 50/249; H01M 50/209; H01M 50/224; H01M 2220/20

(57) ABSTRACT

A battery pack assembly method includes engaging an enclosure structure with manufacturing equipment, changing a size of a cell-receiving opening in the enclosure structure using the manufacturing equipment, inserting at least one cell stack into the cell-receiving opening, and disengaging the manufacturing equipment from the enclosure structure.

### CROSS-REFERENCE TO RELATED APPLICATIONS

This application claims priority to U.S. Provisional Application No. 63/322,766, which was filed on 23 Mar. 2022 and is incorporated herein by reference

### TECHNICAL FIELD

This disclosure relates generally to a method of assembling a traction battery pack and, more particularly, to how cell stacks are moved into an enclosure of the battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a battery pack assembly method, including: engaging an enclosure structure with manufacturing equipment; changing a size of a cell-receiving opening in the enclosure structure using the manufacturing equipment; inserting at least one cell stack into the cell-receiving opening; and disengaging the manufacturing equipment from the enclosure structure.

In some aspects, the techniques described herein relate to a method, wherein the disengaging is after the inserting.

In some aspects, the techniques described herein relate to a method, the changing is after the engaging.

In some aspects, the techniques described herein relate to a method, further including, after the disengaging, compressing the at least one cell stack with the enclosure structure.

In some aspects, the techniques described herein relate to a method, wherein the changing increases a size of the cell-receiving opening.

In some aspects, the techniques described herein relate to a method, wherein a size of the cell-receiving opening reduces in response to the disengaging.

In some aspects, the techniques described herein relate to a method, wherein the enclosure structure includes an enclosure halo.

In some aspects, the techniques described herein relate to a method, wherein the enclosure structure is an enclosure tray.

In some aspects, the techniques described herein relate to a method, wherein the enclosure structure is a metal or metal-alloy.

In some aspects, the techniques described herein relate to a method, wherein each cell stack is disposed along a respective cell stack axis, wherein the inserting moves the at least one cell stack relative to the enclosure structure in a direction that is perpendicular to the cell stack axis.

In some aspects, the techniques described herein relate to a method, wherein the enclosure structure circumferentially surrounds the cell stack after the inserting.

In some aspects, the techniques described herein relate to a method, further including compressing the at least one cell stack during the inserting.

In some aspects, the techniques described herein relate to a method, further including changing the size of the cell-receiving opening by inserting at least one wedge portion into the cell-receiving opening.

In some aspects, the techniques described herein relate to a method, wherein the at least one wedged portion includes a wedge portion of a first prong and a wedge portion of a second prong, and further including, during the inserting, moving the at least one cell stack into the cell-receiving opening from a position where the at least one cell stack is held by the first prong and the second prong.

In some aspects, the techniques described herein relate to a traction battery pack assembly, including: at least one cell stack; and an enclosure structure having a cell-receiving opening that is changed in size to receive the at least one cell stack, the enclosure structure compressing the at least one cell stack.

In some aspects, the techniques described herein relate to a traction battery pack assembly, wherein the enclosure structure is an enclosure tray.

In some aspects, the techniques described herein relate to a traction battery pack assembly, wherein the enclosure structure is a metal or metal alloy.

In some aspects, the techniques described herein relate to a traction battery pack assembly, wherein the at least one cell stack includes a first cell stack having a plurality of individual battery cells disposed along an axis, the enclosure structure compressing the plurality of individual battery cells of the at least one cell stack along the axis.

In some aspects, the techniques described herein relate to a traction battery pack assembly, wherein the cell-receiving opening is within an enclosure halo that is provided by a plurality of side walls of an enclosure tray.

In some aspects, the techniques described herein relate to a traction battery pack assembly, wherein the enclosure structure circumferentially surrounds the at least one cell stack. The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a partially expanded view of a traction battery pack from the electrified vehicle of FIG. 1.

FIG. 3 illustrates a group of cells being compressed to provide a cell stack for the traction battery pack of FIG. 2.

FIG. 4 illustrates the group of cells of FIG. 4 compressed and providing the cell stack.

FIG. 5 illustrates a perspective view of a manufacturing equipment engaging the cell stack of FIG. 4 just prior to insertion of the cell stack into an enclosure structure of the traction battery pack.

FIG. 6 illustrates a close-up, section view showing a prong of the manufacturing equipment holding the cell stack prior to insertion into the enclosure structure.

FIG. 7 illustrates the section of FIG. 6 after a wedge portion of the prong is inserted into the enclosure structure to change a size of cell-receiving opening of the enclosure structure.

FIG. 8 illustrates a perspective view of the prong of FIG. 7 holding the cell stack and inserted into the enclosure structure.

FIG. 9 illustrates the view of FIG. 8 after a pusher of the manufacturing equipment has extended to move the cell stack into the enclosure structure.

FIG. 10 illustrates the view of FIG. 9 after withdrawing the prongs from the cell-receiving opening and disengaging the manufacturing equipment from the cell stack.

### DETAILED DESCRIPTION

This disclosure details example traction battery pack assemblies having an enclosure that provides an interior area. Battery cells and electronic modules can be held within the interior area along with other components. The battery cells can be used to power an electric machine.

In particular, this disclosure details an exemplary systems and methods relating to assembling traction battery pack assemblies.

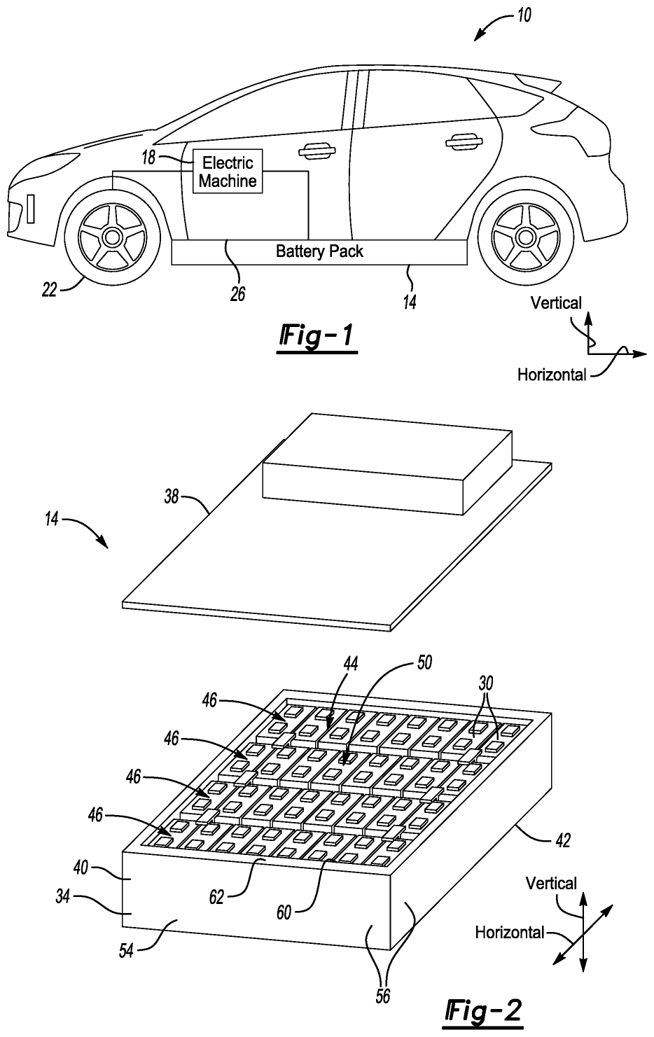

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the traction battery pack assembly 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38, an enclosure halo 40, and an enclosure floor 42. The enclosure cover 38, enclosure halo 40, and enclosure floor 42 are secured together to provide an interior area 44 that houses the plurality of battery cells 30.

The plurality of battery cells (or simply, “cells”) 30 are for supplying electrical power to various components of the electrified vehicle 10. The battery cells 30 are stacked side-by-side relative to one another to construct one of a plurality of cell stacks 46, which are positioned side-by-side to provide a cell matrix 50. In this example, each cell stack 46 includes eight individual battery cells 30, and the cell matrix 50 includes four cell stacks 46.

Although a specific number of battery cells 30 and cell stacks 46 are illustrated in the various embodiments of this disclosure, the traction battery pack assembly 14 could include any number of cells 30 and cell stacks 46. In some examples, using an even quantity of battery cells 30 and an even quantity of cell stacks 46 can help to support and efficient electrical bussing arrangement. In other words, this disclosure is not limited to the specific configuration of cells 30 shown in FIG. 2.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure halo 40 and enclosure floor 42 are, in this example, parts of an enclosure tray 54. In particular, the enclosure halo 40 is provided by a plurality of side walls 56 of the enclosure tray 54. The side walls 56 are arranged relative to one another to provide a cell-receiving opening 60. The side walls 56 can be extruded, roll formed, cast, molded or other structures connected together by welding, fastening, or bonding, for example. The side walls 56 can extend vertically upward from the enclosure floor 42. The side walls 56 and the remaining portions of the enclosure

When the traction battery pack assembly 14 is assembled, the enclosure cover 38 can be secured to vertically upper side 62 of the enclosure halo 40. An interface between the enclosure cover 38 and the enclosure halo 40 extends circumferentially continuously about the interior area 44. Mechanical fasteners or welds, for example, can be used to secure the enclosure cover 38 and the enclosure halo 40. Vertical, for purposes of this disclosure, is with reference to ground and a general orientation of the electrified vehicle 10 during operation.

When the traction battery pack assembly 14 is assembled, the cell matrix 50 is positioned within the cell-receiving opening 60. The example enclosure halo 40 includes one cell-receiving opening 60, but it should be understood that this disclosure also extends to enclosure assemblies providing more than one cell-receiving opening. The enclosure cover 38 can cover the cell matrix 50 within the cell-receiving opening 60 to substantially surround the cells 30 from all sides.

The enclosure halo 40 compresses and holds the cell matrix 50 after the cell matrix 50 is inserted into the cell-receiving opening 60 of the enclosure halo 40. In this example, the side walls 56 of the enclosure halo 40 apply forces to the cell matrix 50 when the cell matrix 50 is positioned within the cell-receiving opening 60.

The traction battery pack assembly 14 can be considered a cell-to-pack battery assembly. Unlike conventional traction battery pack battery assemblies, a cell-to-pack battery assembly incorporates battery cells or other energy storage devices into the enclosure assembly 34 without the cells being arranged in arrays or modules. The enclosure assembly 34 applies compressive forces to the cells. The cell-to-pack battery assembly may therefore eliminate most, if not all, of the array support structures used in conventional battery arrays (e.g., array frames, spacers, rails, walls, endplates, bindings, etc.) that are used to group and hold the battery cells within the arrays/modules.

The cell matrix 50 comprises a plurality of separate cell stacks 46, which can be separately inserted into the cell-receiving opening 60 of the enclosure halo 40. To insert the example cells stacks 46, the cell stacks 46 are, while compressed, moved into place in the cell-receiving opening 60. Spacers may be used to maintain spacing between the different cell stacks 46. The cell stacks 46 each include a group of cells 30 disposed along an axis.

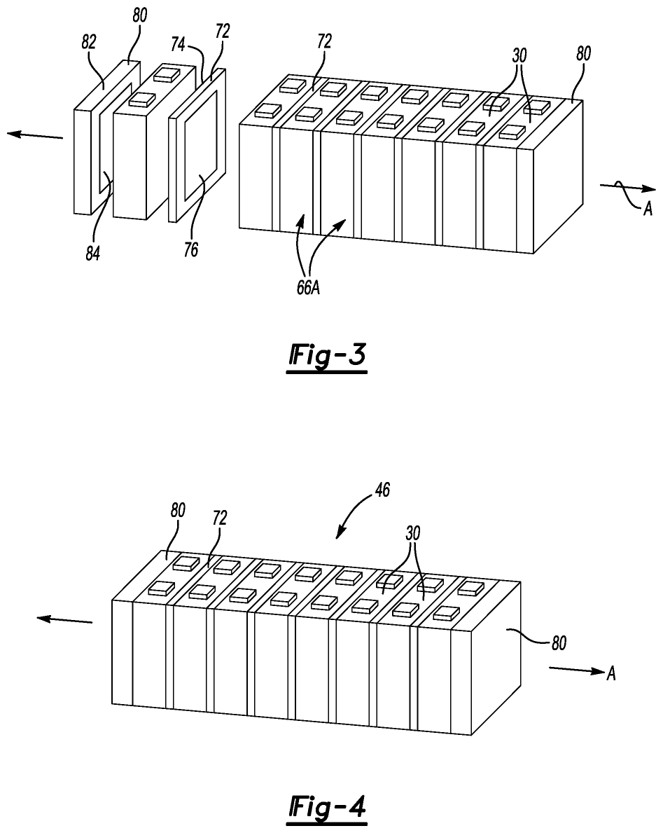

An exemplary method of assembling the traction battery pack assembly 14 will now be explained in connection with FIGS. 3-10. First, the group of cells 30 is compressed along a cell stack axis A as shown in FIG. 3 to provide one of the cell stacks 46. A compression fixture could be used to compress the cells 30 for example. The compressive force exerted on the cells 30 can be 3 kilonewtons in some examples. An actuator, for example, could drive the compression fixture to compress the cells 30 along the cell stack axis A.

In this example, within the cells stacks 46, separator plates 72 are disposed between each of the cells 30 along the cell stack axis A. The separator plates 72 can include a frame portion 74 that holds a compressible material 76. The compressible material 76 can compress to permit some expansion of the cells 30 when installed with the traction battery pack assembly 14. The compressible material 76 can be foam.

Opposing axial ends of each of the cell stacks 46 includes load plates 80. The load plates 80 include a frame portion 82 that holds a compressible material 84. The compressible material 76 can be foam. The compressible material 84 can compress to permit some expansion of the cells 30.

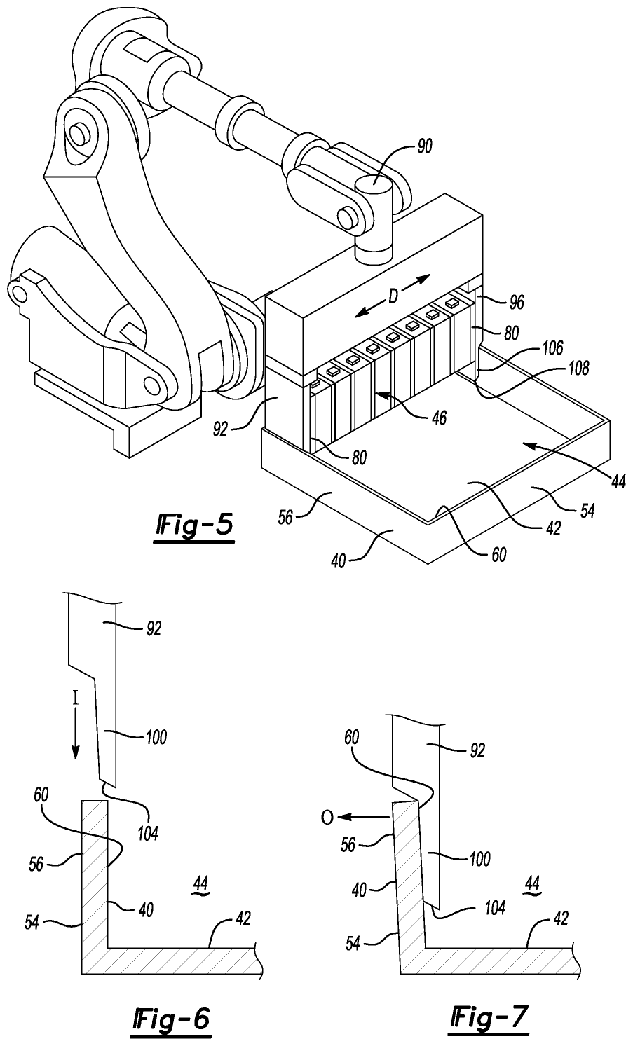

Next, as shown in FIG. 5, the cell stack 46 is engaged by manufacturing equipment 90, which can maintain a compressive load on the cell stack 46 when engaging the cell stack 46. In this example, the manufacturing equipment 90 enages the cell stack 46 that was already compressed by a compression fixture, for example. In other examples, the manufacturing equipment 90 is responsible for applying the initial compressive forces to the group of cells 30 to provide the cell stack 46.

The example manufacturing equipment 90 is a 7-axis device. The example manufacturing equipment 90 includes, among other things, a first prong 92 and a second prong 96 that are used to directly engage the cell stack 46. The manufacturing equipment 90 can move the first prong 92 and the second prong 96 back-and-forth relative to each other along an axis D to selectively increase or decrease a distance between the first prong 92 and the second prong 96.

To engage the cell stack 46, the first prong 92 and the second prong 96 are each placed alongside a respective one of the load plates 80. The first prong 92 and the second prong 96 are then moved closer together to grip the load plates 80 and grasp the cell stack 46. While one first prong 92 and one second prong 96 is shown in this example, other examples could include more than one first prong and more than one second prongs.

With reference now to FIGS. 6-10, the first prong 92 includes a wedge portion 100 having an angled leading edge 104. The second prong 96 is similarly configured with a wedge portion 106 having an angled leading edge 108.

In this example, after engaging the cell stack 46, the manufacturing equipment 90 moves to insert the wedge portion 100 of the first prong 92 into the cell-receiving opening 60. The wedge portion 106 of the second prong 96 is also moved into the cell-receiving opening 60. The angled leading edge 104 can help to guide insertion as the wedge portion 100 and the wedge portion 106 in a direction I (FIG. 6) into the interior area 44.

The wedge portion 100 of the first prong 92 and the wedge portion 106 of the second prong 96 are, in this example, inserted into the cell-receiving opening 60 prior to the cell stack 46. Inserting the wedge portion 100 of the first prong 92 and the wedge portion 106 of the second prong 96 can enlarge the cell-receiving opening 60. Enlarging the cell-receiving opening 60 facilitates insertion of the cell stack 46 into the cell-receiving opening 60 of the enclosure tray 54.

In particular, during insertion, the wedge portion 100 of the first prong 92 and the wedge portion 106 of the second prong 96 press the side walls 56 of the enclosure tray 54 to flex the side walls 56 outward in a direction O as shown in FIG. 7. This stretches the enclosure tray 54. The flexing outward of the side walls 56 changes the size of the cell-receiving opening 60. The amount of movement of the side walls 56 can be less than five millimeters.

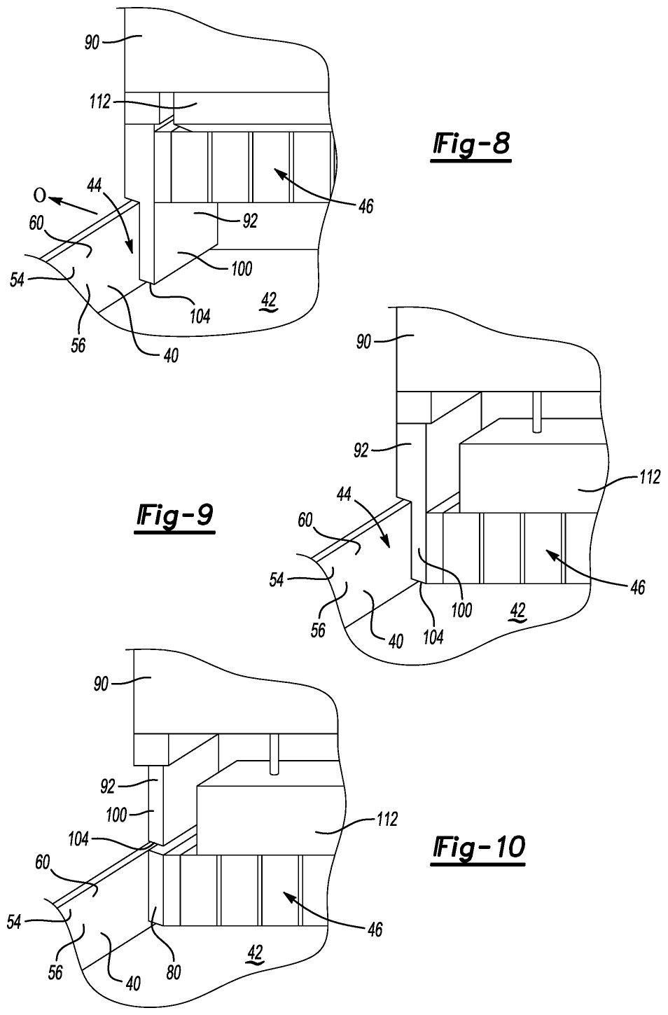

After the wedge portion 100 of the first prong 92 and the wedge portion 106 of the second prong 96 are inserted into the interior area 44 to change the size of the cell-receiving opening 60 as shown in FIG. 8, a pusher 112 of the manufacturing equipment 90 is actuated from a retracted position to an extended position. Extending he pusher pushes the cell stack 46 into the cell-receiving opening 60 from the position of FIG. 8 to the position of FIG. 9. The load plates 80 of the cell stack 46 slide relative to the first prong 92 and the second prong 96 when pushed by the pusher 112. In this example, the cell stack 46 is pushed and inserted into the cell-receiving opening 60 in a direction that is perpendicular to the axis A of the cell stack.

The first prong 92 and the second prong 96 can then be withdrawn from the cell-receiving opening 60 as shown in FIG. 10 while the pusher 112 holds the position of the cell stack 46. This disengages the manufacturing equipment 90 from the cell stack 46. The side walls 56 of the enclosure tray 54 then spring back inward against the load plates 80. The inward movement of the side walls 56 reduces a side of the cell-receiving opening and is in response to the disengaging.

After withdrawing the first prong 92 and the second prong 96, the example cell stack 46 can expand slightly along axis A causing the load plates 80 to directly contact the side walls 56 of the enclosure tray 54. The side walls 56 directly contacting the load plates 80 maintains some compressive force on the cell stack 46. The process is repeated to load the remaining cells stacks 46 into the enclosure tray 54.

The enclosure cover 38 can be secured to the enclosure tray 54 after the cell stacks 46 and other components are positioned within the enclosure tray 54. The enclosure cover 38 can be secured using mechanical fasteners, for example. The traction battery pack assembly 14 can then be installed into the electrified vehicle 10 of FIG. 1.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly method, comprising:
engaging an enclosure structure with manufacturing equipment;
changing a size of a cell-receiving opening in the enclosure structure using the manufacturing equipment;
inserting at least one cell stack into the cell-receiving opening; and
disengaging the manufacturing equipment from the enclosure structure.

2. The method of claim 1, wherein the disengaging is after the inserting.

3. The method of claim 1, wherein the changing is after the engaging.

4. The method of claim 1, further comprising, after the disengaging, compressing the at least one cell stack with the enclosure structure.

5. The method of claim 1, wherein the changing increases a size of the cell-receiving opening.

6. The method of claim 1, wherein a size of the cell-receiving opening reduces in response to the disengaging.

7. The method of claim 1, wherein the enclosure structure includes an enclosure halo.

8. The method of claim 1, wherein the enclosure structure is an enclosure tray.

9. The method of claim 1, wherein the enclosure structure is a metal or metal-alloy.

10. The method of claim 8, wherein each cell stack is disposed along a respective cell stack axis, wherein the inserting moves the at least one cell stack relative to the enclosure structure in a direction that is perpendicular to the cell stack axis.

11. The method of claim 1, wherein the enclosure structure circumferentially surrounds the cell stack after the inserting.

12. The method of claim 1, further comprising compressing the at least one cell stack during the inserting.

13. The method of claim 1, further comprising changing the size of the cell-receiving opening by inserting at least one wedge portion into the cell-receiving opening.

14. The method of claim 13, wherein the at least one wedged portion includes a wedge portion of a first prong and a wedge portion of a second prong, and further comprising, during the inserting, moving the at least one cell stack into the cell-receiving opening from a position where the at least one cell stack is held by the first prong and the second prong.

15. A traction battery pack assembly, comprising:
at least one cell stack; and
an enclosure structure having a cell-receiving opening that is changed in size to receive the at least one cell stack, the enclosure structure compressing the at least one cell stack.

16. The traction battery pack assembly of claim 15, wherein the enclosure structure is an enclosure tray.

17. The traction battery pack assembly of claim 15, wherein the enclosure structure is a metal or metal alloy.

18. The traction battery pack assembly of claim 15, wherein the at least one cell stack includes a first cell stack having a plurality of individual battery cells disposed along an axis, the enclosure structure compressing the plurality of individual battery cells of the at least one cell stack along the axis.

19. The traction battery pack assembly of claim 15, wherein the cell-receiving opening is within an enclosure halo that is provided by a plurality of side walls of an enclosure tray.

20. The traction battery pack assembly of claim 19, wherein the enclosure structure circumferentially surrounds the at least one cell stack.
